(19) United States
(12) Patent Application Publication
(10) Pub. No.: US 2007/0064774 A1
(43) Pub. Date: Mar. 22, 2007

(54) System, station, device and method for obtaining quantities

(75) Inventors: Sel Brian Colak, Eindhoven (NL); Martin Ouwerkerk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/573,313

(22) PCT Filed: Sep. 17, 2004
(86) PCT No.: PCT/IB04/51789

§ 371 Date: Mar. 24, 2006

(30) Foreign Application Priority Data
Sep. 29, 2003 (EP) 03103588.4

(51) Int. Cl. H04B 1/00

(52) U.S. Cl. 375/147

(57) ABSTRACT

In an interrogation system (100) with a station (101) and a passive device (102), the station (101) interrogates the passive device (102) for a quantity (103) by transmitting an electromagnetic pulse (105). The passive device (102) has a cavity (109) that influences an ultrawideband reflection of the electromagnetic pulse (105) by the passive device (102). The quantity (103) of the passive device (102) influences a physical property (110) of the cavity (109). The station ((101) receives and analyses the reflection to obtain the quantity (103).

The invention relates to an interrogation system comprising a station for obtaining a quantity of a passive device by interrogating the passive device.

The invention also relates to a station and a device for use in such an interrogation system.

The invention also relates to a method of obtaining a quantity of a passive device.

Such an interrogation system is known from the frame labeled “Panel 2. First use of modulated backscatter”, Bell Labs Technical Journal, Autumn 1996, page 210, the frame being part of the article “A Low-Cost Radio for an Electronic Price Label System”, Bell Labs Technical Journal, Autumn 1996, pages 203-215.

The frame describes a wireless system used for eavesdropping the American Embassy in Moscow. In this system, a station transmits a radio wave with a frequency of 330 MHz to a passive device with a cavity resonant at the frequency. An acoustic diaphragm of the device causes a modulated backscattered signal, carrying the ambassador's voice.

It is a disadvantage of the known interrogation system that it is sensitive to interference from other radio frequency sources with the same frequency.

It is an object of the invention to provide a system of the kind described in the opening paragraph, which is relatively insensitive to interference from other radio frequency sources.

This object is realized in that the station comprises: transmitting means for transmitting an electromagnetic pulse; receiving means for receiving, from the passive device, a modulated ultra-wideband reflection of the electromagnetic pulse; demodulating means for demodulating the reflection and obtaining the quantity, the demodulating means being coupled to the receiving means, and in that the passive device is arranged to transmit the modulated ultra-wideband reflection to the station, the passive device comprising a cavity for modulating the reflection in dependence upon the quantity, the cavity having a physical property, the physical property being dependent on the quantity.

Since a modulated ultra-wideband reflection of the electromagnetic pulse spreads its energy over many frequencies, the system is relatively insensitive to interference from other radio frequency sources. Another advantage is that the passive device may be relatively small, particularly when relatively high frequencies are used. A further advantage is that the system may comprise a plurality of passive devices that can be interrogated simultaneously, without requiring a directive antenna emitting the electromagnetic pulse.

The transmitted pulse may have an ultra-wideband of radio frequencies, but it may also be a light beam. The pulse typically has a duration of the order of nanoseconds, obtaining a spectral energy density with a frequency range having a lower limit and an upper limit. The lower limit is in the GHz to THz range. The upper limit is in the range from tens of GHz to hundreds of THz.

The cavity may substantially have the shape of a regular body, for example, a sphere, a hemisphere, a cylinder, or a polyhedron. The cavity may be open or closed. The physical property of the cavity may be one or more of its dimensions, but may also be another property, for example a property of the media filling the cavity or surrounding the cavity, for example, surface conductivity or magnetic susceptibility. The cavity has at least one resonance frequency that is modulated in dependence upon the property. The cavity may be a Fabry-Perot cavity, which is considered to be known to a person skilled in the art.

The demodulating means process the received modulated reflection. The demodulating means may be based on a correlation architecture having branches, where each branch has an oscillator, a mixer and a correlator. Each branch is dedicated to processing a frequency area around a cavity resonance frequency. A baseband processor can process the output signals from the branches, to obtain the quantity.

It is noted that the same article discloses a system replacing paper price labels for retail businesses. This system has a plurality of electronic price tags and a station to provide the price tags with pricing information. The price tag has a display for displaying the provided pricing information and a battery to provide power for its electronic circuits and the display. The problem addressed by the system is that of distributing the pricing information wirelessly to price tags. The system comprises active, battery-powered price tags with a relatively high complexity and a relatively high cost.

Advantageously, the passive device has an identity, the passive device being further arranged to modulate the reflection in dependence upon the identity, the demodulating means being further arranged to obtain the identity from the reflection. The system may comprise a plurality of devices, where the station can wirelessly identify each device, because the device reveals its identity by modulating the reflection. The identity of the device may be, for example, one or more of its dimensions causing one or more specific spectral components to be reflected. The dimensions of the device give it an ultra-wideband fingerprint. The device may serve as a key with a unique identity when the device has a sufficiently complex shape. The shape may comprise a meander, a comb, a grating, a spiral, a maze, a labyrinth, or a concentric structure, or a plurality or combinations thereof.

Advantageously, the cavity has physical dimensions, the quantity being determined by the ratio of at least two of the physical dimensions. This may decrease the sensitivity of the interrogation to disturbances from the environment. An example is that the size of a device will generally vary with temperature. By determining the quantity as the ratio of two suitable physical dimensions of the cavity, the influence of the temperature is reduced. This also applies to the identity, improving the identification of the device.

Advantageously, the demodulating means comprise spectral component analysis means for obtaining a spectral component of the reflection, the spectral component analysis means being coupled to the receiving means. The spectral component analysis means may comprise a correlator and an integrator. This provides relatively simple demodulation means.

Advantageously, the spectral component analysis means comprise:

an A/D converter for converting the received reflection into a digital signal, the A/D converter being coupled to the receiving means, and

a Fourier transformer for performing a Fourier transform on the digital signal. This may optimize the demodulating means, as it allows a processor to operate on many branches, alleviating the need to have full demodulators for each branch. Another advantage is that processing of the aggregate of signals of the branches is simplified.

Advantageously, the demodulating means comprise a replica of the cavity. This measure can provide a relatively simple demodulator. The replica is not modulated by the quantity. The reflection is guided to the replica. Dependent on the interrogated quantity, the replica will resonate in response to being excited with the reflection. Detecting a resonant cavity is relatively simple. The demodulating means may also comprise other replicas, each with another quantity, and modulated with fixed deviations from the cavity.

Advantageously, the electromagnetic pulse comprises a light beam, and the passive device comprises a non-linear optical unit for transforming the light beam into the ultra-wideband reflection. The light beam may propagate with relatively little decay through a medium between the station and the device. Therefore, relatively much energy arrives at the device. The non-linear optical unit converts the energy into the ultra-wideband reflection. One example of a medium in which a light beam has relatively little decay is a human body. The light beam may originate from a laser. The laser may provide sub-picosecond infrared pulses with wavelengths in the range of 700 to 1500 nanometers. The passive device may work like a photo-conductive THz antenna made of a semi-insulating material like GaAs, which is sandwiched as an asymmetric metal-insulator-metal diode. Due to the asymmetry, a built-in potential discharges as the optical infrared beam pulses hit on it. The sub-picosecond electric pulse gets filtered by the cavity structure. The non-linear optical unit may comprise LiTaO₃, in which optical rectification generates a pulsed THz beam. This is known as Cherenkov rectification. Alternatively, the passive device may comprise Si with a built-in surface electric field on one side. Due to the Frans-Keldysh effect, optical rectification takes place close to the surface. Still alternatively, the passive device may comprise pn junctions, photonic band gap structures, or photonic crystals.

These and other aspects of the interrogation system will be further elucidated and described with reference to the drawing.

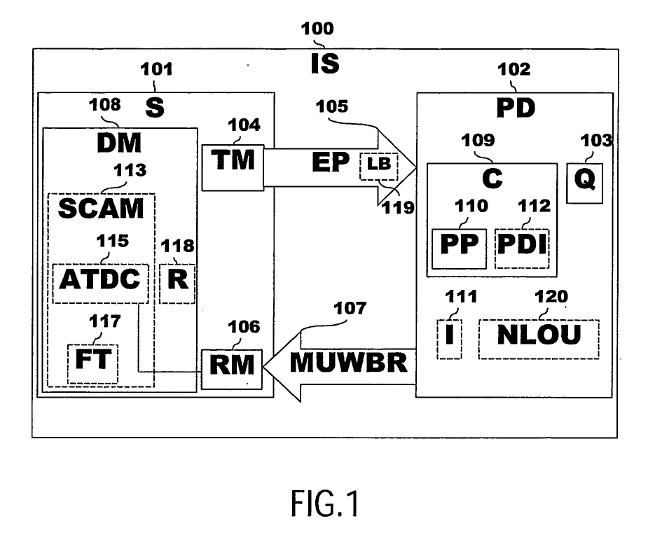

FIG. 1 is a block diagram of an interrogation system according to the invention.

In FIG. 1, an interrogation system 100 comprising a station 101 and a passive device 102 is shown schematically. The passive device 102 has a quantity 103. The quantity 103 may be, for example, a position, an orientation, an angle, a temperature, a gas pressure, a fluid pressure, a fluid flow, a sound pressure, a force, acceleration, gravity, humidity and a light intensity. Both the station 101 and the passive device 102 may be portable, mobile or stationary. The station 101 can interrogate the passive device 102 for the quantity 103. The interrogation is initiated from the station 101 with the transmission of an electromagnetic pulse 105. The electromagnetic pulse 105 may have a wide frequency spectrum, but it may alternatively have a relatively narrow frequency spectrum. The station 101 comprises transmitting means 104 to transmit the electromagnetic pulse 105. The electromagnetic pulse 105 propagates through a medium to the passive device 102. The station 101 comprises receiving means 106 for receiving, from the passive device 102, a modulated ultra-wideband reflection 107 of the electromagnetic pulse 105. This is described in more detail below. The station 101 comprises demodulating means 108 for demodulating the reflection and obtaining the quantity 103. The demodulating means 108 may be based on the known principles of demodulation and are coupled to the receiving means 106.

Ultra-wideband may be defined as a property of a signal with a spectral power density. The spectral power density has a maximum value at a central frequency. The spectral power density decreases to a fraction of the maximum value, both at an upper frequency larger than the central frequency, and at a lower frequency smaller than the peak frequency.

In one example of a definition of ultra-wideband, the signal has the property if the difference between the upper frequency and the lower frequency exceeds a certain frequency limit. In a typical definition, the fraction equals −10 dB and the frequency limit equals 0.5 GHz.

In another example of a definition of ultra-wideband, the signal has the property if the difference between the upper frequency and the lower frequency divided by the central frequency exceeds a ratio. In a typical definition, the fraction equals −10 dB and the ratio equals 0.25.

The electromagnetic pulse 105 falls on the passive device 102 comprising a cavity 109. The cavity 109 has a physical property 110, which is dependent on the quantity 103. The physical property may be one or more of the dimensions of the cavity, an electric field, a magnetic flux, a magnetic susceptibility, a dielectric constant, a polarization, or an atomic lattice. The passive device 102 reflects part of the energy of the electromagnetic pulse 105. The reflection is dependent on the shape, the geometry and the materials of the passive device 102 and of the cavity 109. Because of the dependency of the cavity 109 on the quantity 103, the reflection is also dependent on the quantity 103. Phrased differently, the cavity 109 modulates the reflection in dependence upon the quantity 103. In addition, the reflection may depend on other factors. The passive device 102 reflects the modulated ultra-wideband reflection 107 to the station 101.

Having a spherical passive device 102 may decrease the angular dependence to the incident electromagnetic pulse 105. This may be characterized as Mie scattering, with dielectric spheres. This is considered to be known to a person skilled in the art. The passive device 102 may alternatively be a dielectric rod, a metallic shell, a slot antenna backed by a hemispherical cavity, or an array of reflecting cantilevers. For an electromagnetic pulse 105 with spectral components in the THz range, the passive device 102 may be smaller than a millimeter. The passive device 102 may be manufactured by means of MEMS technology.

Interrogation can take place wirelessly and remotely, because the station 101 and the passive device 102 only need to be coupled by a medium suited for propagating the electromagnetic pulse 105 and the modulated ultra-wideband reflection 107. As the device is passive, it may be relatively cheap.

The passive device 102 with a cavity resonator structure offers antenna and sensing functionalities in a single physical component. The purpose is to simplify the structure of the passive device 102 to make it suitable for lower costs and lower power. In a crowded network environment, passive devices showing a single resonant property may not be uniquely addressed without extensive multiple access communication (MAC) protocols. A passive device with a single resonance may need extensive electronics with additional components, raising costs and power consumption. Therefore, passive cavity structures having differing resonances or a multitude of resonances may be employed, with each device having unique spectral features. These features are still contained within a single component passive device. In order to address these devices effectively and simultaneously, the station 101 may probe the passive devices 102 with ultra-wideband electromagnetic pulses 105. The passive devices 102 communicate by using spectrally the principle of code division multiple access (CDMA), using their unique resonance features. Since ultra-wideband pulses have a broad spectral coverage, all of the CDMA components of the passive devices 102 can be probed simultaneously.

Since the main resonances of the passive cavities 109 are perturbed by the sensed quantities 103 from the environment, the time-dependent modulated parts of the reflected signals 107 from the devices 102 carry the sensed information back to the station 101 and to a main network to help provide ambient intelligence functionality. The station 101 may be connected to a conventional network, such as Ethernet or WiFi, which provides the means for data and signal processing and communications.

One example is that a cavity 109 boundary changes its position in dependence upon the quantity 103, causing a change in the geometry of the cavity.

The passive device 102 may have an identity 111. The passive device 102 may be further arranged to modulate the reflection in dependence upon the identity 111. This effectively provides the station 101 with a fingerprint of the passive device 102. The system may comprise at least one other passive device 102 having another identity 111 and having another quantity 103. The station 101 may interrogate both the passive device 102 and the at least one other passive device 102 substantially simultaneously. The station 101 may interrogate both devices for their respective quantity 103 with a single electromagnetic pulse 105. The demodulating means 108 may be further arranged to obtain the identity 111 from the reflection.

A single interrogation system 100 may comprise a relatively large amount of passive devices. As the passive devices may be relatively cheap, the interrogation system 100 may be relatively cheap, even when the system contains, for example, thousands of passive devices. The wireless coupling between the station 101 and each of the passive devices avoids the costs of a wired coupling. This is also advantageous if the passive devices move with respect to the station 101.

The cavity 109 may have physical dimensions 112. The quantity 103 may be determined by the ratio of at least two of the physical dimensions 112. Instead of the quantity 103, also the identity 111 may be determined by the ratio of at least two of the physical dimensions 112. Using a ratio may decrease the sensitivity of the interrogation system 100 for spurious effects.

The demodulating means 108 may comprise spectral component analysis means 113 for obtaining a spectral component of the reflection. The spectral component analysis means 113 are coupled to the receiving means 106.

The spectral component analysis means 113 may comprise an A/D converter 115 and a Fourier transformer 117. The A/D converter 115 converts the received reflection into a digital signal. The A/D converter 115 is coupled to the receiving means 106. The Fourier transformer 117 performs a Fourier transform on the digital signal.

The demodulating means 108 may comprise a replica 118 of the cavity 109. The replica may provide relatively simple demodulation means 108. The replica 118 may also increase a sensitivity of the demodulation means 108 for detecting changes in the quantity 103.

The electromagnetic pulse 105 may comprise a light beam 119. The passive device 102 may comprise a non-linear optical unit 120 for transforming the light beam 119 into the ultra-wideband reflection.

The interrogation system 100 may also include means for other known modulation techniques.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the article “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An interrogation system (100) comprising:
a station (101) for obtaining a quantity (103) of a passive device (102) by interrogating the passive device (102), the station (101) comprising:
transmitting means (104) for transmitting an electromagnetic pulse (105);
receiving means (106) for receiving, from the passive device (102), a modulated ultra-wideband reflection (107) of the electromagnetic pulse (105);
demodulating means (108) for demodulating the reflection and obtaining the quantity (103), the demodulating means (108) being coupled to the receiving means (106), and
the passive device (102) for transmitting the modulated ultra-wideband reflection (107) to the station (101), the passive device (102) comprising a cavity (109) for modulating the reflection (107) in dependence upon the quantity (103), the cavity (109) having a physical property (110), the physical property (110) being dependent on the quantity (103).

2. An interrogation system (100) as claimed in claim 1, characterized in that the passive device (102) has an identity (111), the passive device (102) being further arranged to modulate the reflection in dependence upon the identity (111), the demodulating means (108) being further arranged to obtain the identity (111) from the reflection.

3. An interrogation system (100) as claimed in claim 1, characterized in that the cavity (109) has physical dimensions (112), the quantity being determined by the ratio of at least two of the physical dimensions (112).

4. An interrogation system (100) as claimed in claim 1, characterized in that the demodulating means (108) comprise spectral component analysis means (113) for obtaining a spectral component of the reflection (107), the spectral component analysis means (113) being coupled to the receiving means (106).

5. An interrogation system (100) as claimed in claim 4, characterized in that the spectral component analysis means (113) comprise:
an A/D converter (115) for converting the received reflection into a digital signal, the A/D converter (115) being coupled to the receiving means (106), and
a Fourier transformer (117) for performing a Fourier transform on the digital signal.

6. An interrogation system (100) as claimed in claim 1, characterized in that the demodulating means (108) comprise a replica (118) of the cavity (109).

7. An interrogation system (100) as claimed in claim 1, characterized in that the electromagnetic pulse (105) comprises a light beam (119), and the passive device (102) comprises a non-linear optical unit (120) for transforming the light beam (119) into the ultra- wideband reflection (107).

8. A station (101) for use in the interrogation system (100) as claimed in claim 1.

9. A passive device (102) for use in the interrogation system (100) as claimed in claim 1.

10. A method of obtaining a quantity (103) of a passive device (102) with a cavity (109) having a physical property (110) by interrogating the passive device (102), the method comprising the steps of:
transmitting an electromagnetic pulse (105) to the passive device (102);
receiving a modulated ultra-wideband reflection (107) of the electromagnetic pulse (105) as modulated by the cavity (109) in dependence upon the physical property (110) being affected by the quantity (103);
demodulating the modulated ultra-wideband reflection (107) received; and
obtaining the quantity (103).
